(19) United States
(12) Patent Application Publication
(10) Pub. No.: US 2021/0387026 A1
(43) Pub. Date: Dec. 16, 2021

(54) BREATHING MASK AND HOOD

(71) Applicant: Alejandro CORTINA-CORDERO, MEXICO (MX)

(72) Inventor: Alejandro CORTINA-CORDERO, MEXICO (MX)

(73) Assignee: Jose Pablo CORTINA-CORDERO, CIUDAD DE MEXICO (MX)

(21) Appl. No.: 17/006,768

(22) Filed: Aug. 28, 2020

(30) Foreign Application Priority Data
Jun. 16, 2020 (MX) MX/U/2020/000215

(51) Int. Cl. A62B 18/02; A62B 23/02; A62B 18/04; A62B 18/08; A62B 18/10; A41D 13/11

(52) U.S. Cl. CPC A62B 18/025; A62B 23/02; A41D 13/1153; A62B 18/084; A62B 18/10; A62B 18/04

(57) ABSTRACT

A breathing mask having an elongated body having inhalation and exhalation compartments, each of which having openings and valve members over the openings and filters, and a hood assembly having a hood cover, made of a fabric to cover the top, nape and sides of a wearer's head, a transparent face shield connected to the hood cover, which has an upper portion of sight and a lower portion for breathing; the breathing mask is inserted into a hole inside the face shield and secured to it by means of a seal.

### CROSS-REFERENCE TO RELATED APPLICATION

The present application claims priority to Mexican utility mode application No. MX/u/2020/000215, filed on Jun. 16, 2020, the content of each of which in its entirety is included herein by reference.

### FIELD OF INVENTION

The invention relates to a breathing mask with an air filter for protecting a user from disease by contact with pathogens agents. In addition, it refers to a hood that contains the breathing mask.

### BACKGROUND OF THE INVENTION

Nowadays the personal protection equipment (PPE) that are used by personnel in a hospital are: the hygienic mask (N95 or similar), the face shield, the cap for the hair and glasses and goggles of security. Goggles have the disadvantage of being attached in a tighten way to the tissue adjacent to the eyes which are sensitive. The googles also prevent air from coming into contact with the eyes, which, in addition to being uncomfortable, is considered as a harmful effect on health.

Usually the masks include filtering elements that are effective, however, such elements are expensive and have a limited lifespan. A main drawback is that the moisture contained in the breath degrades the filtering material and contaminates them.

In addition, the use of PPE equipment has several drawbacks for people wearing eyeglasses. Particularly the use of masks and face shield implies condensation of moisture coming from breathing (CO₂ plus H₂O) which usually results in fogged lenses. On the other hand, the combined use of masks and face shield results in the fogging on the plastic face shields. In addition to the use of PPE equipment and face shields, the World Health Organization recommends the use of caps or head covers, which makes the use of such safety equipment even more inconvenient.

In addition, hoods are common for extreme cases of pollution of all types, such as viruses, toxic gases and radioactive environments. These hoods are commonly equipped with powered filtering breathing mask that “inject” purified air in the suit and maintain a positive pressure within the hood thus ensuring the flushing of carbon dioxide and the supplying of oxygen free of harmful substances from the suit or the hood. Such equipment is expensive and scarce.

A filter mask with improved performance is desirable, as well as having an increased lifetime. It is also desirable, a more comfortable equipment, which incorporates all the features of equipment PPE, face shields, filter masks and covers.

### SUMMARY OF THE INVENTION

A first object of the invention is to provide a breathing mask that has improved performance and extended lifespan.

A second object of the invention is to provide a personal protection equipment that incorporates the benefits of face shields, breathing masks and covers, in a single equipment.

Another object of the invention is to provide a personal protection equipment in which it is prevented the condensation of water on the inner surface of the face shield.

Another object of the invention is to provide a personal protection equipment that includes a seal between the face shield and the breathing mask.

Embodiments of the invention achieve the above objectives by providing a breathing mask, comprising: (a) an elongated body (44) having (i) an inhalation compartment 46a and (ii) an exhalation compartment 46b; (iii) an inhalation opening 47a arranged over the inhalation compartment 46a, and (iv) an exhalation opening 47b arranged over the exhalation compartment 46b; (v) an inhalation valve member 48a arranged over the inhalation opening 47a, and (vi) an exhalation valve member 48b arranged over the exhalation opening 47b; (b) an inhalation filter 45a arranged in the inhalation compartment 46a and an exhalation filter 45b arranged in the exhalation compartment 46b, such filters being the same or different material, integral (45) or non-integral (45a, 45b); and (c) a closure 49, removable, to ensure integral filter 45, or filters 45a and 45b to the elongated body 44.

A hood assembly comprising: (a) a cover hood, of a cloth covering the top, nape and sides of a wearer's head; (b) a transparent face shield, attached to the hood, having an upper portion of sight and a lower portion of breath; (c) a breathing mask, of an elongated body including a filtering element, the mask attached to the face shield; wherein the breathing mask is inserted into an aperture on the face shield and secured to this by means of a seal.

The hood assembly of the invention has been designed to avoid transmission of diseases, although it also has other uses such as in carpentry or painting.

### BRIEF DESCRIPTION OF THE DRAWINGS

The details of one or more aspects of a characteristic of the hood of the present invention are described in this document with reference to the following drawings. The same numbers are used throughout the drawings to refer to similar features and components:

FIG. 1 shows an exploded view of the breathing mask of the present invention.

FIG. 2 shows the breathing mask placed on a user's face.

FIG. 3 shows the hood assembly of the present invention.

FIG. 4 illustrates a cut-off view showing the assembly of the breathing mask with the face shield of the hood assembly of the present invention.

### DETAILED DESCRIPTION

FIG. 1 shows the breathing mask 41 of the present invention. The breathing mask 41 comprises an elongated body 44. At one end includes a joint 43 to seal the wearer whole mouth and nose, with the breathing mask 41. In addition, the breathing mask 41 has an inhalation compartment 46a and an exhalation compartment 46b, both compartments have respective inhalation and exhalation openings 47a and 47b through which air flows to the user in inhalation, or to the outside in exhalation.

Openings 47a and 47b each includes a support for fixing a respective inhalation and exhalation valve member 48a and 48b, forming thus a check valve. At least one integral filter 45, or two separate filters 45a and 45b for each compartment, are provided over the inhalation and exhalation compartments 46a, 46b.

In a preferred embodiment, the valve members 48a and 48b include a fixing bolt that is inserted into an aperture arranged on the support of the inhalation and exhalation openings. The arrangement of the valve members is inverted, so that in inhalation, the exhalation valve member blocks the exhalation opening and the air cannot enter through the exhalation opening, while the inhalation valve member opens and air flows from the inhalation compartment 46a and through the inhalation opening to the user. On the other hand, in exhalation, the inhalation valve member 48a blocks the air flow through the inhalation opening 47a to the outside, while the exhalation valve member 48b opens and allows the exit of air through the exhalation opening 47b to the outside.

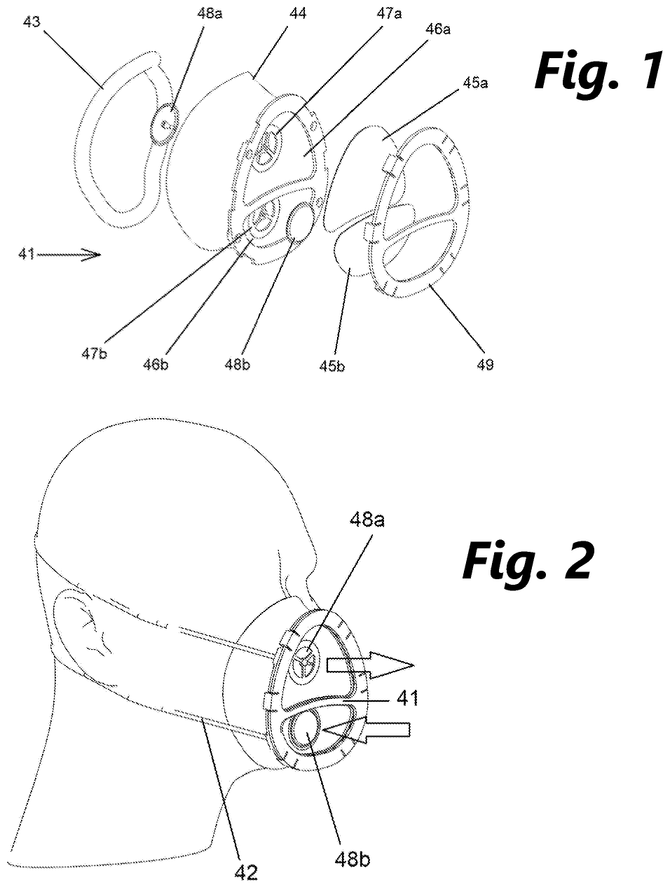

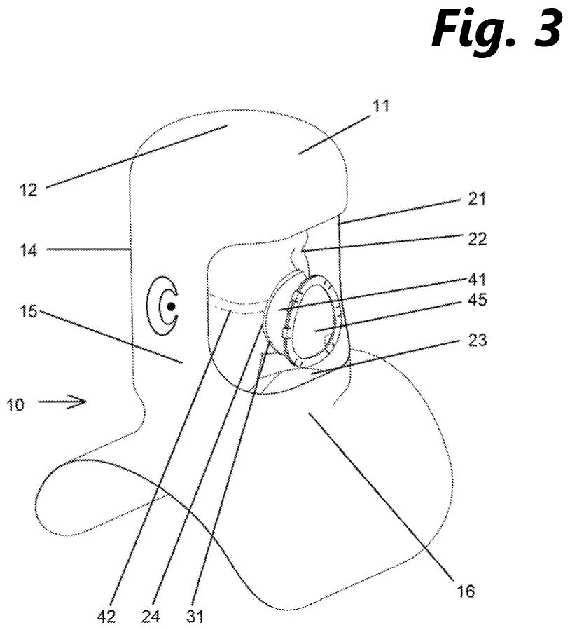

The inhalation compartments can be of suitable shape and dimensions. FIGS. 1 and 2 show that the inhalation compartment is arranged at the top of the breathing mask while the exhalation compartment is located at the bottom of the breathing mask. However, as will be apparent to a skilled in the art, the lower compartment can be used as an inhalation compartment and the upper compartment as an exhalation compartment. In this embodiment, the valve member arrangement is exchanged, so that the functionality of the openings 47a, 47b is exchanged, that is, the lower opening 47b can admit air (inhalation), while the upper opening 47a can expel air (exhalation).

Both inhalation and exhalation compartments 46a and 46b, include an inhalation and exhalation filter 45a and 45b, the filter is made of the same filter material or different filter materials. It is preferred to use filters 45a and 45b of different filtering materials and therefore with different characteristics. The filter 45a in the inhalation compartment 46a is one of a high filtration requirement material, while the exhalation filter 45b in the exhalation compartment 46b can be a material with lower filtration requirements. Filtration standards are well known in the field. One with ordinary skills in the pertinent art would understand that it is enough to provide a sheet of effective filtering material, known for example Pellon, non-woven filter material N95, etc.

Therefore, by ensuring that the exhalation air is discharged to the outside through the exhalation compartment, wet exhalation air is prevented from coming into contact with the high-requirement filter 45a and from degrading and contaminating it, thereby extending the life of filter 45a. In FIG. 2, the inhalation and exhalation flow of air are represented, as well as the arrangement of the inhalation and exhalation valve members 48a and 48b. The inhalation process produces a vacuum that tends to displace the valve member 48a to allow air to enter, while the exhalation valve member 48b blocks the opening and prevents the passage of air. Instead, in the exhalation process, the valve member 48b is pushed to allow air to pass outward, while the inhaler valve member 48b blocks the opening and prevents air from entering.

Alternatively, it is provided an integral filter 45 that covers both surfaces of the inhalation and exhalation compartments 46a, 46b.

The breathing mask of the invention also comprises a closure 49, which is attached to the elongated body 44, in order to keep in place the inhalation and exhalation filters 45a and 45b, or optional integral filter 45. The closure includes a snap closure, so that the separate filters 45a and 45b, or the integral filter 45, can be removed from the breathing mask for cleaning and eventual replacement.

In another aspect of the invention, a hood assembly 10 is provided in accordance with the present invention, which is shown in FIG. 3. The hood comprises a hood cover 11, which has an upper part 12, a back part 14 and right and left side parts 15. The hood cover 11 also includes a hood skirt 16. In use the upper part 12, back 14 and sides 15 cover the top of the head, the nape and the side parts, while the skirt 16 extends at the neck of the person who wears the hood and can even cover a part of the chest.

In an alternative embodiment of the invention, the hood includes holes in the side parts, in order to increase the perception of sounds from outside to the interior of the hood assembly in order to prevent the user from putting himself at risk by isolating himself from external noises. As depicted, the hood cover 11 may have fins that reflect sound waves to the orifices, similar to artificial ears.

The hood cover 11 is made from a non-woven or woven material, for example a cotton, nylon or other well-known fibers in the art. The use of a non-woven web of polypropylene is preferred, which is a low-cost waterproof material, which also provides a disposable character to the hood.

The hood assembly of the present invention also comprises a transparent face shield 21, the face shield has an upper portion or portion of sight 22 and a lower portion of breath 23, so that the face shield substantially covers the entire face of the user, so it's easier to identify the person who wears the hood assembly of the invention. In the lower portion 23 there is a face shield opening 24 that coincides with the position of the whole nose and mouth of the user.

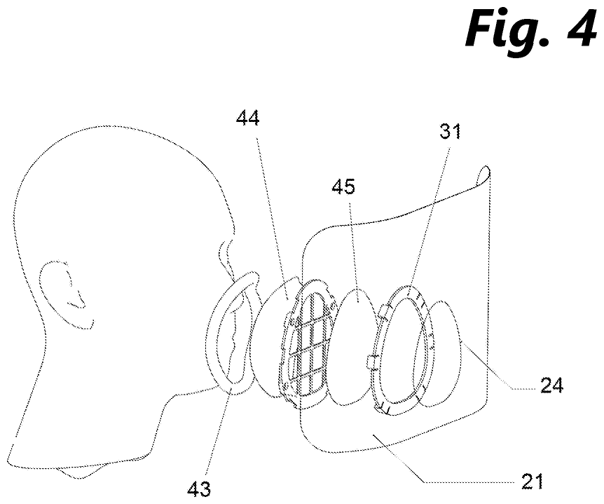

The hood cover 11 may be joined to the face shield by removable means. For example, through mechanical means (not depicted) such as Velcro™, to attach and detach the face shield 21 from the hood cover 11. The transparent face shield 21 is made preferably of a thermoplastic or thermosetting polymeric material, for example polyester, polyethylene or polycarbonate. The face shield 21 consists of a plate that has none or little light distortion, so that the user can see through it. The face shield can have different geometries. For example, it can include a lateral fold, as shown in FIG. 4, or folds on each side, that is, lateral, upper, and lower folds, similar to a box. In addition, it may have one or more curvature radio.

The main difference between the invention and other hoods of the prior art is that in the hood assembly of the invention a breathing mask 41 of half face is advantageously arranged, which constitutes a conduit to the outside, to the environment outside the hood, but that connection is sealed so that eyes and hair are protected, which if not covered, could easily house a virus. This is to say, even when the head is totally covered within the hood assembly of the invention, inhalation and exhalation are carried out to the outside of the hood and through a filtering medium. The whole nose and mouth lie in a different compartment than the rest of the face, the whole nose and mouth are connected to the outside by the breathing mask provided with an air filter.

FIG. 4 shows the arrangement of the invention. The breathing mask 41 comprises an elongated body 44. At one end of the elongated body 44 there is a joint 43 of the whole nose-mouth. Said joint is made of a soft material, which has some adhesion to the human skin but does not irritate the skin. Silicone joints are preferred, but rubber joints with a surface treatment are also acceptable. The breathing mask 41 also includes an elastic fastener 42, attached to the elongated body 44, which is placed around the head of the wearer and aims to keep the breathing mask 41 tightened on the whole nose-mouth of the wearer. The breathing mask on the user's whole nose-mouth provides a suitable support for the face shield 21 and for the hood cover 11 that is placed on the face shield 21. In this way, the hood assembly 10 of the invention is supported on the whole nose-mouth and on the top of the head, which results in preventing the face shield from falling on the user's face by the action of gravity, and bringing the face shield uncomfortably too close to the user's face. And therefore, it does not require a harness supported on the forehead of the wearer in order to support the face shield 21 as required in the simple face shields of the prior art.

To attach the breathing mask 41 to the face shield 21, the breathing mask 41 is inserted into a face shield opening 24 on the face shield 21, and it's held in the face shield 21 by means of a seal 31 that keeps the breathing mask 41 attached to the face shield 21, with a stiffness sufficient not to detach from face shield 21 but capable of sliding under a higher pulling force, so that the breathing mask 41 can be removed from the face shield 21 for cleaning or for replacement of filter elements 45 (or elements 45a, 45b) and replaced maintaining a hermetic seal against the passage of ambient air.

The seal 31 consists of a ring that attaches to the face shield opening 24. It is made of a flexible and resistant material such as rubber, optionally includes a tab towards the center of the opening 24 and in use tightens against the outer wall of the elongated body 44 of the breathing mask 41, to form a seal.

As can be seen from the embodiment of FIG. 4, at the end of the elongated body 44 there is a filter element 45. A filter material sheet is used as filter element 45, this versatility is especially important when there is a shortage of specialized filters as occurs in a pandemic situation.

In another embodiment of the invention, a hood is arranged in combination with the breathing mask 41 shown in FIGS. 1 and 2, it is to say a breathing mask 41 comprising (a) an elongated body (44) which has (i) an inhalation compartment 46a and (ii) an exhalation compartment 46b; (iii) an inhalation opening 47a on the inhalation compartment 46a, and (iv) an exhalation opening 47b on the exhalation compartment 46b; (v) an inhalation valve member 48a on the inhalation opening 47a; and (vi) an exhalation valve member 48b on the exhalation opening 47b; (b) an inhalation filter 45a in the inhalation compartment 46a and an exhalation filter 45b in the exhalation compartment 46b; such filters of the same or different material, integral (45) or non-integral (45a, 45b); and (c) a removable closure 49, to ensure integral filter 45, or filters separated 45a and 45b to the elongated body 44 of the mask.

As it is known, water in the form of steam is a by-product of respiration. Water in the form of steam condenses when it comes into contact with a surface at a lower temperature. In this case the water vapor in contact with lenses or with a face shield leads to the formation of vapor condensate on the inner surface of the face shield. The breathing mask and face shield arrangement of the invention prevents the formation of steam condensates on the face shield. With the hood assembly 10 of the invention, the water steam is expelled by the breathing mask to the outside, which provides an environment within the hood free of moisture by the breath of the user. In addition, the air entering the user is fresh air from the environment.

The main benefits and benefits in terms of utility include:

a) A single PPE team replaces a face shield, a hygienic mask, a head cover and goggles.

b) It is much more economical, easier to use, lighter, easier to clean or sterilize the hood assembly of the present invention than the set of Positive Pressure Respirators (PPR) equipment of the prior art.

c) By exhaling outside the hood assembly, the carbon dioxide and water do not accumulate inside the hood assembly as well as the heat of the exhalation, for this reason the plastic cover of the hood does not get fogged, a common problem in face shields of the prior art.

d) The outside air, inhaled, enters cooler than the air inside the hood.

e) Another benefit lies in the possibility that the user can wear eyeglasses, without restriction of shape or size, unlike the use of face shields or full face masks and goggles of the prior art.

f) the visual landscape is wider, and the sense of seclusion is less in comparison with the use of goggles and full face mask models. In general, the prolonged use of googles and masks produces severe headaches, but not while wearing the hood assembly of the present invention.

g) Another benefit is that the wearer's communication to the outside is improved with respect to other half-face or full-face masks, this is mentioned as an issue of great importance for Doctors because of the inability to communicate with their patients and collaborators.

h) A very important aspect is that the use of hygienic masks or surgical masks is not safe at all since the ergonomic design of the masks does not always fit to the user face, since remaining spaces or openings between the wearer face and the mask may allow viruses or harmful substances to pass through. The cover hood acts as a second layer of protection in the event that the breathing mask does not perfectly fit to the user's face, if there is an opening between the mask and the face, the air to be breathed would not come from the possibly contaminated unfiltered air from the outside but from the environment in the hood assembly.

i) The hood of the invention may or may not use special filters, in a preferred embodiment, pieces of filter materials are used, such as masks N95, filters P100, or others. In the case of not having access to certified materials, non-woven webs such as Pellon can be used, while some cotton fabrics are not preferred, due to the fact that their filtering capacity is not ideal.

The hood can be produced at a very low cost and can be used in a massive way at all hierarchical levels and positions within an organizational structure of a hospital, without this representing an unaffordable investment.

In terms of supplies, it is more convenient to distribute a single piece of equipment than several pieces of equipment of different sizes and qualities.

Although aspects of the hood assembly of the invention have been disclosed, the subject matter of the claimed invention is not necessarily limited to the specific features described herein. Rather, the specific features and methods have been described as an example implementation of the hood assembly, and other equivalent features and methods are intended to be within the scope of the claimed invention. In addition, various aspects of a different nature have been described, and it will be appreciated that each aspect described can be implemented independently or in relation to one or more of the other aspects described.

### LIST

10 Hood assembly
11 Hood cover
12 Top part of Hood
14 Back part of Hood
15 Side part of Hood
16 Hood Skirt
21 Face Shield
22 Upper Portion of Sight
23 Lower Portion of Breath
24 Face Shield Opening
31 Breathing Mask Seal
41 Breathing Mask
42 Mask Elastic Fastener
43 Whole Nose-Mouth Joint
44 Elongated body
45 Integral Filter Element
45a Inhalation Filter
45b Exhalation Filter
46a Inhalation Compartment
46b Exhalation Compartment
47a Inhalation Opening
47b Exhalation Opening
48a Inhalation valve member
48b Exhalation valve member
49 Closure

What is claimed is:

1. A breathing mask, comprising:
An elongated body (44) having an inhalation compartment (46a) and an exhalation compartment (46b);
wherein an inhalation opening (47a) is arranged over the inhalation compartment (46a), and an exhalation opening (47b) arranged over the exhalation compartment (46b);
and wherein an inhalation valve member (48a) is arranged over the inhalation opening (47a), and an exhalation valve member (48b) arranged over the exhalation opening (47b);
an inhalation filter (45a) arranged in the inhalation compartment (46a) and an exhalation filter (45b) arranged in the exhalation compartment (46b), such filters being the same or different material, integral 45 or non-integral (45a, 45b); and
a removable closure (49) to secure filters (45a) and (45b) to the elongated body (44) of the mask.

2. The breathing mask, according to claim 1, wherein the inhalation filter (45a) is made of a material with a high filtration requirement, while the filter (45b) is made of a material with a low filtration requirement.

3. The breathing mask, according to claim 1, wherein a single integral filter (45) is place in both inhalation and exhalation compartments (46a, 46b).

4. The breathing mask, according to claim 1, wherein the inhalation compartment cavity is larger than the exhalation compartment cavity.

5. A hood assembly comprising:
a) a hood cover (11), of a cloth covering the top, nape and sides of a wearer's head,
b) a face shield (21), transparent, attached to hood cover (11), having an upper portion of sight (22) and a lower portion of breath (23),
c) A breathing mask (41), of a tubular body including a filter element (45), attached to face shield (21);
wherein the breathing mask (41) is inserted into a hole inside the face shield (21) and secured by means of a seal (31).

6. The hood assembly according to claim 5, wherein the seal (31) consists of a flexible rubber ring.

7. The hood assembly according to claim 5, wherein that the hood is made of a non-woven material of hydrophobic and impermeable polypropylene.

8. The hood assembly according to claim 5, wherein the hood includes fins that reflect sound waves to ear holes.

9. The hood assembly according to claim 5, wherein the face shield (21) is made of a thermoplastic or thermosetting material, which is selected from polyester, polyethylene or polycarbonate.

10. The hood assembly according to claim 5, wherein the breathing mask (41) comprises an elongated body (44), having at one end a joint (43) for the whole nose-mouth of a wearer, an elastic fastener mask (42), attached to the elongated body (44), to attach the breathing mask to the user's head and an interchangeable filter element (45), arranged at the opposite end of the elongated body (44) of the breathing mask.

11. The hood assembly according to claim 5, wherein the breathing mask (41) includes:
an elongated body mask (44) having an inhalation compartment (46a) and an exhalation compartment (46b);
an inhalation opening (47a) arranged over the inhalation compartment (46a), and an exhalation opening (47b) arranged over the exhalation compartment (46b);
an inhalation valve member (48a) arranged over the inhalation opening (47a) and an exhalation valve member (48b) arrange over the exhalation opening (47b);
an inhalation filter (45a) arranged in the inhalation compartment (46a) and an exhalation filter (45b) arranged in the exhalation compartment (46b), such filters being the same or different material, integral 45 or non-integral (45a, 45b); and
a removable closure (49) to secure the integral filter or separate filters (45a) and (45b) to the elongated body (44) of the mask.

12. The hood assembly according to claim 11, wherein the inhalation filter (45a) is of a material with a high filtration requirement, while the filter (45b) is of a material with a low filtration requirement.

13. The hood assembly according to claim 11, wherein having a single integral filter (45) in both inhalation and exhalation compartments (46a, 46b).

14. The hood assembly according to claim 11, wherein the inhalation compartment cavity (46a) is larger than the exhalation compartment cavity.
